(19) United States
(12) Patent Application Publication
(10) Pub. No.: US 2025/0181126 A1
(43) Pub. Date: Jun. 5, 2025

(54) HEAT SINK ASSEMBLY

(71) Applicant: Apple Inc., Cupertino, CA (US)

(72) Inventors: Devinne Cullinane, San Francisco, CA (US); Edward S Huo, Sunnyvale, CA (US); Ritu Shah, Sunnyvale, CA (US); Teodor Dabov, San Francisco, CA (US)

(21) Appl. No.: 18/862,032

(22) PCT Filed: Jun. 1, 2023
(86) PCT No.: PCT/US2023/024206

§ 371 Date: Oct. 31, 2024

Related U.S. Application Data
(60) Provisional application No. 63/365,766, filed on Jun. 2, 2022.

(51) Int. Cl. G06F 1/20; G06F 1/16; H01Q 1/00; H01Q 1/02; H01Q 1/22

(52) U.S. Cl. CPC G06F 1/203; G06F 1/1698; H01Q 1/002; H01Q 1/02; H01Q 1/2266

(57) ABSTRACT

An electronic device includes a heat generating component, an electrical ground, a radio-frequency (RF) sensitive component, a conductor extending from the heat generating component to the electrical ground, and a non-metallic barrier at least partially surrounding the conductor and disposed between the conductor and the RF sensitive component. An electronic component includes a heat source, an electrical ground, a non-conductive body defining a pathway extending from the heat source to the electrical ground, and a conducting material disposed in the pathway.

### CROSS-REFERENCE TO RELATED APPLICATION(S)

This application is a National Stage filing based off of PCT Application No. PCT/US2023/024206, filed 1 Jun. 2023, and entitled “HEAT SINK ASSEMBLY” which claims priority to U.S. Provisional Patent Application No. 63/365,766, filed 2 Jun. 2022, and entitled “HEAT SINK ASSEMBLY,” the entire disclosure of which is hereby incorporated by reference.

### FIELD

The described embodiments relate generally to electronic components. More particularly, the present embodiments relate to heat dissipating electronic components and methods of minimizing interference with radio-frequency sensitive components.

### BACKGROUND

A recent trend in the design of consumer electronics includes the miniaturization of electronic computing devices. This trend is driven by the consumer's desire for portable, compact, and lightweight devices that maintain the same functionalities as previous devices. Such devices can include personal computers, smartphones, head-mountable displays for alternate/virtual reality (AR/VR) devices, smartwatches, and other wearable electronic devices. These devices include a multitude of electronic components producing heat that must be removed for the electronic device to function as intended. Often, heat management strategies and electrical grounding within devices are limiting factors for how small a device can be. This is because the smaller and more compact the device is, the faster the heat can travel from one component to another within the device, and the less space there is for positioning heat dissipation and electrical grounding components.

In many examples, heat and electrical conduction components create a conduction path, allowing a heat source to transfer thermal energy from one region to another region where the thermal energy can be dissipated by thermal conduction or convection. Conduction components can be primarily metal, which can provide efficient transfer of thermal energy and electricity. As the size of portable computing devices has decreased, electronic components, including heat dissipating and electrical grounding components, can be placed in closer proximity to other components providing different functions, such as an antenna.

However, when heat dissipating and/or electrical grounding components are used, radio-frequency (RF) noise can be produced. This RF noise can affect the performance of other electronic components, such as antennas, which can negatively impact functionality. Additionally, as electrical grounding and heat dissipating components become smaller and more delicate, they can be prone to failure, including bending, twisting, or breaking with use over time.

Therefore, what is needed in the art are structurally durable electronic components capable of dissipating heat and grounding electricity that can be placed in close proximity to other electronic components without producing significant amounts of RF interference when in use.

### SUMMARY

In one example of the present disclosure, an electronic device includes a heat generating component, an electrical ground, a radio-frequency (RF) sensitive component, a conductor extending from the heat generating component to the electrical ground, and a non-metallic barrier at least partially surrounding the conductor and disposed between the conductor and the RF sensitive component.

In one example, the conductor can include metal. In one example, the heat generating component can include a light-emitting diode (LED). In one example, the non-metallic barrier can define a pathway through which the conductor extends. In one example, the RF sensitive component includes an antenna. In one example, the antenna is a first antenna and the electronic device further includes a second antenna. In one example, the non-metallic barrier is disposed between the conductor and the first antenna, and between the conductor and the second antenna. In one example, the electronic device further includes a housing defining an internal volume and an aperture. In one example, the heat generating component includes an LED configured to emit light through the aperture. In one example, the RF sensitive component is disposed in the internal volume.

In one example of the present disclosure, an electronic component includes a heat source, an electrical ground, a non-conductive body defining a pathway extending from the heat source to the electrical ground, and a conducting material disposed in the pathway.

In one example, the conducting material includes a thermal paste. In other examples, the conducting material includes a metal. In one example, the body includes a plastic material. In one example, the pathway is tortuous. In another example, the pathway extends in three dimensions.

In one example of the present disclosure, an electronic device includes a first electronic component, a second electronic component, an RF barrier extending from the first electronic component to the second electronic component, a pathway defined by the RF barrier, and a conductor extending through the pathway and coupling the first electronic component and the second electronic component.

In one example, the electronic device further includes an antenna disposed adjacent to the RF barrier. In one example, the RF barrier is disposed between the conductor and the antenna. In one example, the conductor includes a thermal paste.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example of an electronic device;

FIG. 2 shows another example of an electronic device;

FIG. 3 shows another example of an electronic device;

FIG. 4 shows another example of an electronic device, including a heat generating component, a conductor, and a barrier;

FIG. 5 shows another example of an electronic device, including a heat generating component, a conductor, multiple RF sensitive components, and a barrier;

FIG. 6 shows another example of an electronic device, including a heat generating component, a conductor, multiple RF sensitive components, and a barrier;

FIG. 7 shows an example of an electrical component, including a body defining a pathway extending from a heat source to an electrical ground;

FIG. 8A shows a front view of another example of an electrical component, including a body defining a pathway extending from a heat source to an electrical ground; and

FIG. 8B shows a side view of the electrical component of FIG. 8A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments, as defined by the appended claims.

Devices described herein are related to electronic components. More particularly, the present embodiments relate to electrical grounding and heat dissipating electronic components and methods of minimizing interference with radio-frequency sensitive components. In one example, an electrical grounding and heat dissipating electronic component configured to dissipate heat away from and electrically ground a heat generating component can include a conductor extending from the heat generating component and through which thermal and/or electrical energy can flow. An electrical ground can provide a termination point wherein the energy can be dispersed. In addition, a non-metallic barrier, such as plastic, can at least partially surround the conductor and be capable of shielding other nearby components, such as antennas, from frequencies that can be produced by the heat dissipating electronic component. In this way, other components sensitive to frequencies produced by the heat dissipating electronic component can be placed in closer proximity to the heat dissipating electronic component and accompanying heat dissipation components.

In one example, an electronic device can include a heat source such as a light-emitting diode (LED) with a necessary grounding path, for example, a conductor which can be made of metal or another conductive material, by which the LED is grounded. In addition, a non-metallic component capable of structurally supporting the conductor and shielding the conductor portion of the LED can be included. In this way, the RF emissions can be reduced, minimizing the required placement distance from an RF sensitive device. In another example, the aforementioned heat dissipating electronic component can be disposed between multiple antennas and can reduce RF emissions radially such that the distance between multiple antennas and the heat generating and dissipating electronic components can be minimized, resulting in a tightly packed configuration of RF sensitive components in the vicinity of the conductor. In such a tightly packed configuration, the non-metallic component can increase or maximize a distance between a metal or other conductive material of the conductor and the RF sensitive components by providing structural support to a smaller conductor and creating a barrier between the conductor and the RF sensitive components.

In another example, an electronic device with heat dissipating components can include a heat source with a grounding path, an electrical ground, and a non-metallic body defining a torturous pathway extending from the heat source to an electrical ground. The pathway can extend in three dimensions, such as a helical path that circularly traverses a first and second axis, which can be normal in orientation, creating a first plane, while remaining concentric with a third axis perpendicular to the first plane. The body defining the pathway can be created by use of additive manufacturing, molding, or other methods, and can terminate at the electrical ground. In such an example, an electrically and thermally conductive fluid or paste can be used to fill the tortuous pathway. In this way, the heat source is able to transmit energy through the electrically conductive fluid via the tortuous pathway to the electrical ground. The tortuous nature of the path can be designed specifically to wind through various other components that may be sensitive to the heat dissipation, including nearby RF sensitive components and antennas, which can be placed in multiple positions relative to the heat generating component and/or the pathway.

In another example, an electronic device including a heat dissipating component can include a grounding path, an electrical ground, and a non-metallic body containing a torturous path extending from a heat source to an electrical ground. The non-metallic portion can be compliant, able to sustain mechanical stresses that can induce bending, torsion, elongation and other similar stresses that can be produced, while still maintaining an electrical pathway wherein energy can be transmitted from a heat source to an electrical ground by means of a thermal paste or other conductive fluid, liquid, or material.

The examples noted above and described below in more detail provide heat dissipation within electronic devices that enable a more compact design. The electrical grounding and heat dissipation components effectively ground and dissipate energy (including heat and electricity) from heat generating electronic components, while shielding the heat path from interfering with nearby RF sensitive components. In this way, those components can be placed in closer proximity to the heat dissipation path, enabling a more compact design, while maintaining or improving device functionalities. In addition, electrical grounding and heat dissipation components and systems described herein can be structurally sound and durable such that the miniaturization of the device and grounding/dissipation components does not reduce the life of the device nor the life and performance of each component over time.

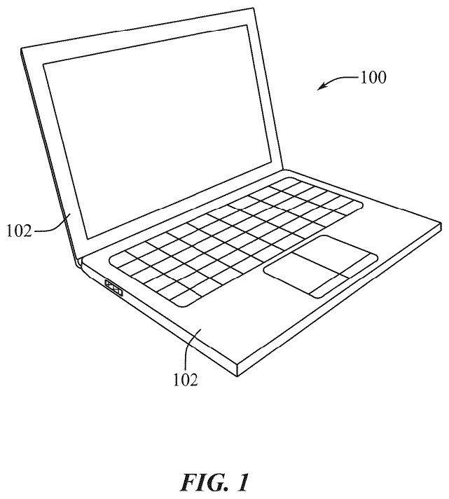

These and other embodiments are discussed below with reference to FIGS. 1-8B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or a combination thereof (e.g., two of the first option and one of the second option).

FIG. 1 illustrates an example of an electronic computing device 100 having a compact design. The device 100 is a laptop computer having multiple functions, including visual and audio outputs, internet connectivity, electronic communication capabilities, and computing functionalities. These functions can be enabled by a multitude of components, including processors, antennas, display components, screens, and lights, input components such as keyboards and touchpads, and so forth. Many of these electronic components produce heat during operation, which should be managed and dissipated without interfering or damaging nearby components of the device 100. These components should also be electrically grounded for proper operation. The electrical grounding and heat dissipating devices and systems described herein can be included in device 100 to manage and dissipate heat while also providing a ground to the components.

In one example, the device 100 can include a housing 102 or multiple housings defining an internal volume. The heat generating components can be disposed within the internal volume or outside the internal volume. In on example, the heat generating component can communicate with the ambient environment through the housing. For example, the electronic heat generating component can be an LED disposed at or on the housing 102, or within the housing 102 and directing light through an aperture defined by the housing 102. The electrical grounding and heat dissipation components and systems described herein can be disposed within the internal volume defined by the housing 102, but can be connected or coupled to the heat generating component, such as an LED, to direct heat and electricity to a grounding component or a heat sink disposed within the internal volume.

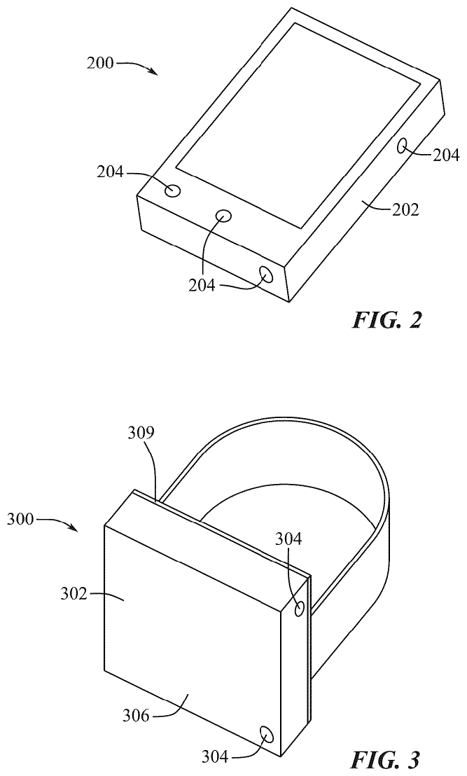

FIG. 2 shows another example of an electronic device 200, including a smartphone having a housing 202 defining an internal volume and an external surface of the device 200. The smartphone 200 can also include a number of heat generating electronic components, including display/touch screens and one or more lights 204 can be disposed at various locations on, above, or within the housing 202 as shown. In one example, the lights 204 can be notification lights or visual icons disposed within the internal volume or outside the internal volume defined by the housing 202 of the device 200. In on example, the lights 204 can communicate with the ambient environment through the housing 202. For example, one or more of the lights 204 can be an LED disposed at or on the housing 202, or within the housing 202, and directing light through an aperture defined by the housing 202.

In the illustrated example of FIG. 2, the lights 204 can include heat generating LEDs that produce heat and require electrical grounding. The heat dissipation and electrical grounding components and systems described herein can be included in the smartphone 200 to dissipate heat generated by the lights 204 and electrically ground the lights 204.

FIG. 3 shows another example of an electronic device 300, including a head-mountable display 300 having a display portion 306. The display portion 306 can include a housing 302 defining an internal volume and one or more heat generating electronic components, including outward facing lights 304. The display portion 306 can also include a display screen 309 or other display component projecting light toward the user's eyes when the user dons the head-mountable display 300. The lights 304 can include one or more LEDs. The lights 304 can be disposed at various locations on, above, or within the housing 302 as shown. In one example, the lights 304 can be notification lights or visual icons disposed within the internal volume or outside the internal volume defined by the housing 302 of the device 300. In on example, the lights 304 can communicate with the ambient environment through the housing 302. For example, one or more of the lights 304 can be a LED disposed at or on the housing 302 or within the housing 302 and directing light through an aperture defined by the housing 302. In other embodiments, the lights 304 can be infrared or other non-visible lights used to aid sensors or other components of the electronic device 300 by illuminating objects with light of a known frequency.

In the illustrated embodiment, the lights 304 can include heat generating LEDs that produce heat and require electrical grounding. The heat dissipation and electrical grounding components and systems described herein can be included in the head-mountable device 300 to dissipate heat generated by the lights 304 and electrically ground the lights 304.

Any of the features, components, and/or parts, including the arrangements and configurations thereof shown in FIGS. 1-3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1-3.

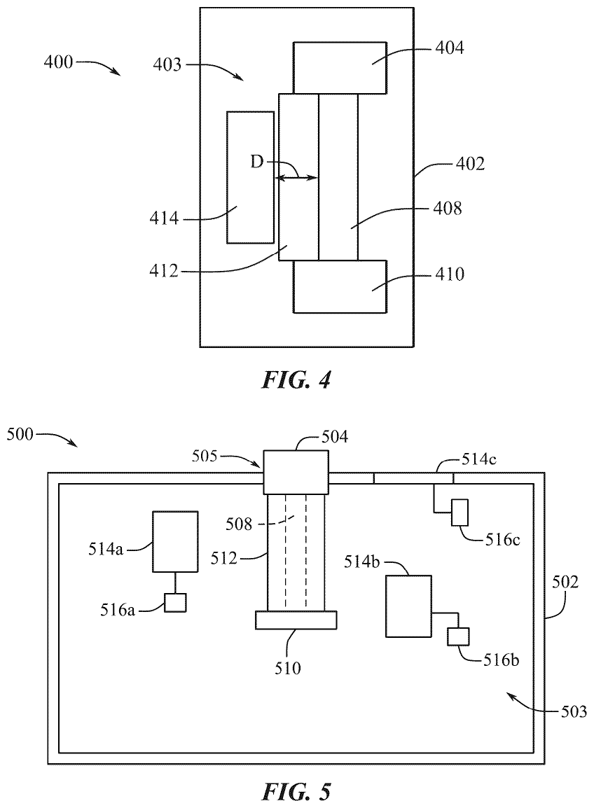

FIG. 4 illustrates an example of an electronic device 400 including a housing 402 defining an internal volume 403. The device 400 can also include a first electronic component 404, a second electronic component 410, and a conductor 408 extending from the first electronic component 404 to the second electronic component 410, as shown. In at least one example, the first electronic component 404, the second electronic component 410, and the conductor 408 can be disposed in the internal volume 403. In one or more other examples, the first electronic component 404 can be disposed outside the housing 402 or within an aperture defined by the housing 402.

In at least one example, the first electronic component 404 can include a heat generating electrical component. In one example, the first electronic component 404 can include an LED producing light. One or more examples of electronic components can include light sources producing light in various light spectra, including visible and infrared wavelengths. In one example, the second electronic component 410 can include an electrical grounding component and/or a heat sink. The second electronic component 410 can be configured to electrically ground the first electronic component 404 and/or conduct and disperse heat generated by the first electronic component 404.

In at least one example, the device 400 can also include a sensitive component 414. In one example, the sensitive component 414 can include an RF sensitive component 414. The RF sensitive component 414 can be any electronic component configured for receiving or sending RF signals, such as an antenna, or any other component sensitive to RF signals whose function would be affected by the electricity or heat conducted through the conductor 408 from the first electronic component 404 to the second electronic component 410. In one example, the RF sensitive component 414 can be a heat sensitive component 414 affected by heat such that changes in temperature affect the function or performance of the heat sensitive component 414. For example, the heat sensitive component 414 could be a component affected by heat generated by adjacent electronic components within the device 400, such as by heat generated by the first electronic component 404, the heat transferred through the conductor 408, and/or the heat absorbed or dispersed by the second electronic component 410.

In at least one embodiment, the device 400 can also include a barrier 412 disposed between the conductor 408 and the sensitive component 414. In one example, the barrier can at least partially surround the conductor 408 to shield the sensitive component 414 from heat and/or electricity conducted through the conductor 408 during use. In examples where the sensitive component 414 is an RF sensitive component 414, the barrier 412 can be an RF barrier 412 configured to block RF interference from the electricity passing through the conductor 408 from the RF sensitive component 414. Likewise, in examples where the sensitive component 414 is a heat sensitive component 414, the barrier 412 can be a heat barrier 412 configured to insulate the heat sensitive component 414 from heat passing through the conductor 408.

A minimum distance “D” between the sensitive component 414 and the conductor 408 can be a design requirement to avoid interference that negatively affects the performance of the sensitive device 414. The closer the sensitive component 414 is to the heat or electricity passing through the conductor 408, the worse the interference may be. In at least one example, the barrier 412 disposed between the conductor 408 and the sensitive component 414 reduces this interference, and thus, reduces the minimum distance D required to reduce interference. In this way, the barrier 412 enables the sensitive component 414 to be disposed closer to the conductor 480 within the device than the sensitive component 414 otherwise could be without the presence of the barrier 412. In this way, the barrier 412 allows for a more compact, smaller form factor of the device 400 without negatively affecting the performance thereof.

In addition, the barrier 412 can be configured to structurally support the conductor 408 such that forces acting on either the first or second electronic components 404, 410 are transferred through the barrier 408 and reducing the forces transferred through the conductor 408. Such forces acting on the first or second electronic components 404, 408 can include impacts from a user dropping the device 400 during use, pressing on either electronic component 404, 410 during use, or other motions, impacts, or contacts resulting in forces acting thereon.

In at least one example, the barrier 412 contacts or is directly or indirectly connected or coupled with the first and/or second electronic component 404, 410 to absorb all forces acting thereon. In at least one example, the barrier 412 contacts or is directly or indirectly coupled with the first and/or second electronic component 404, 410 to absorb at least some of forces acting thereon. In at least one example, the barrier 412 contacts, or is directly or indirectly coupled with, the first and/or second electronic component 404, 410 to absorb a majority of forces acting thereon. In this way, the material of the conductor 408 can be chosen to maximize electrical and heat conduction without limiting the material selection to those materials that also provide necessary structural support to the conductor 408 absent the barrier 412. For example, the conductor can be a soft metal with high conductivity even if the soft metal would otherwise be insufficiently strong without the barrier. In one example, the conductor 408 can include a gel or a liquid conducting material that provides minimal structural support within the device such that the barrier 412 provides much of, or most of, the support.

In at least one example, the barrier can include a durable and strong material, including non-conductive materials such as plastics, rubbers, ceramics, and so forth. In at least one example, the conductor 408 can include any suitable conducting metal, gel, composite material, or ceramic. In one example, the conductor 408 includes aluminum. In one example, the conductor 408 includes copper, gold, or other metals or metal alloys. In one example, the conductor 408 includes sheet metal. The material of the conductor 408 can vary depending on the sensitive component 414 disposed within the device 400 such that the material of the conductor 408 is tuned to reduce RF interference with the sensitive component 414.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates another example of an electronic device 500 including a housing 502 defining an internal volume 503. The housing 502 can define an aperture 505 in which, or through which, a heat generating component 504 is disposed. The device can also include an electrical ground 510 disposed within the internal volume 503. In one example, the electrical ground 510 can be connected to, or can be a part of, the housing 502. In one example, the device 500 can also include one or more RF sensitive components, including a first RF sensitive component 514a, a second RF sensitive component 514b, and a third RF sensitive component 514c. Other examples can include more or less than the three RF sensitive components 514a-c shown in the example of FIG. 5.

In one example, one or more of the RF sensitive components 514a-c can be disposed within the internal volume 503. In one example, one or more of the RF sensitive components 514a-c can be disposed outside the internal volume 503 and/or outside the housing 502. In one example, as illustrated in FIG. 5 at the third RF sensitive component 514c, the housing can include the RF sensitive component 514c or the housing 502 can be an RF sensitive component. In at least one example, one or more of the RF sensitive components 514a-c can include an antenna. Additionally, one or more examples can include antenna circuitry 516a-c, respectively, and other antenna processing components including circuit boards, oscillating components, grounding components, and so forth.

In at least one example, the device 500 also includes a conductor 508 extending from the heat generating component 504 to the electrical ground 510, and a non-metallic barrier 512 at least partially surrounding the conductor 508 and disposed between the conductor 508 and one or more of the RF sensitive components 514a-c. In at least one example, the non-metallic barrier 512 can completely surround the conductor 508. In the illustrated example of FIG. 5, the non-metallic barrier 512 is disposed between the conductor 508 and the first RF sensitive component 514a. The term “between” as used in this context refers to the fact that any RF interference signals potentially emanating from the conductor must first pass through the non-metallic barrier 512, or be blocked thereby, before reaching or interfering with the first RF sensitive component 514a. Accordingly, because the non-metallic barrier 512 is at least partially surrounding the conductor 508, the non-metallic barrier 512 can be disposed between the conductor 508 and multiple RF sensitive components, including between the conductor 508 and the second RF sensitive component 514b and between the conductor 508 and the third RF sensitive component 514c.

In at least one example, the non-metallic barrier 512 defines a pathway through which the conductor 508 extends. In one or more examples, the non-metallic barrier 512 can be molded, additively manufactured, machined, or otherwise formed to define an enclosed pathway extending through the non-metallic barrier 512. The pathway can be an enclosed pathway terminating at openings defined by the barrier 512. The enclosed pathway can include an elongate pathway, for example a tubular pathway, with opposing ends at respective openings defined by the non-metallic barrier 512. A first end of the pathway can terminate at the heat generating component 504 and the second end of the pathway can terminate at the electrical ground 510. The term “enclosed” can refer to a pathway fully defined by the non-metallic barrier 512 such that the only access to the pathway includes opening at either end defined by the non-metallic barrier 512, as noted above. In such examples, the conductor 508 can be disposed at least partially within the non-metallic barrier 512 and can extend through the pathway defined thereby. In at least one example, the conductor 508 can include a metal. In at least one example, the conductor 508 can include a thermal paste. In at least one example, the conductor 508 can include plastic bonded with an embedded metal. In at least one example of the device 500, the heat generating component 504 can include an LED. In at least one example, the LED 504 can be configured to emit light through the aperture 505.

As noted with reference to other examples described herein, the non-metallic barrier 512 of FIG. 5 is configured to shield the nearby RF sensitive components 514a-b and associated components 516a-c from interference caused by electricity conducted through the conductor 508 from the heat generating component 504 to the electrical ground 510. In at least one example, the electrical ground 510 can additionally or alternatively be configured as a heat sink where heat generated by the heat generating component 504 is transferred through the conductor 508 thereto. The non-metallic barrier 512 can also be configured to structurally support the device, including the heat generating component 504, the electrical ground 501, or any other components of the device 500 including the housing 502. In this way, the non-metallic barrier 512 can structurally relieve the conductor 508 and/or the heat generating component 504. In at least one example, the non-metallic barrier 512 can be plastic such that it is not meant to elastically deform as part of its normal function. In at least one example, the non-metallic barrier 512 can include a rigid material that is not meant to be elastically or plastically deformed or bent as part of its functioning to structurally supporting the conductor 508, or other components described herein. While most or all materials may theoretically deform negligibly as forces act thereon, the term “rigid” or “plastic,” as used herein, denotes a material or structure that does not permanently or temporarily deform as part of its normal function.

Accordingly, in the example shown in FIG. 5, the dimensions, size, and configuration of the conductor 508 can be physically minimized to reduce RF interference and heat transfer to other components within the device 500, while the non-metallic barrier 512 carries the forces to maintain or improve durability. The non-metallic barrier 512 can also reduce design requirement for how tightly packed the various RF sensitive components 514a-c can be in relation to the conductor 508, enabling a more physically compact design. Because of this compact design and the reduction in a minimum allowable distance between RF sensitive components 514a-c and the conductor 508, more components of various functionalities can be disposed within the internal volume 503 of the device 500, or on or within the housing 502, such that the functionalities of the device 500 can be greater in number and improved in performance.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

FIG. 6 illustrates another example of an electronic device 600 including a first electronic component 604. In at least one example, the first electronic component can be a heat generating component 604. The device can also include second electronic component 610. In at least one example, the second electronic component 610 can be an electrical ground or a heat sink. In one example, the device 600 can also include one or more RF sensitive components, including a first RF sensitive component 614a and a second RF sensitive component 614b, near or adjacent to the conductor 608. Other examples can include more or less than the two RF sensitive components 614a-b shown in the example of FIG. 6.

In at least one example, one or more of the RF sensitive components 614a-b can include an antenna. In at least one example, the device 600 also includes a conductor 608 extending from the heat generating component 604 to the electrical ground 610 and a non-metallic barrier 612 at least partially surrounding the conductor 608 and disposed between the conductor 608 and one or more of the RF sensitive components 614a-b. In at least one example, the first and/or second RF sensitive components 614a, 614b can be disposed adjacent to the non-metallic barrier 612 such that no other components are disposed therebetween. In the illustrated example of FIG. 6, the non-metallic barrier 612 is disposed between the conductor 608 and the first RF sensitive component 614a. The term “between” as used in this context refers to the fact that any RF interference signals potentially emanating from the conductor must first pass through the non-metallic barrier 612, or be blocked thereby, before reaching or interfering with the first RF sensitive component 614a. Accordingly, because the non-metallic barrier 612 is at least partially surrounding the conductor 608, the non-metallic barrier 612 can be disposed between the conductor 608 and multiple RF sensitive components, including between the conductor 608 and the second RF sensitive component 614b.

In at least one example, the non-metallic barrier 612 can contact or otherwise be coupled with one or more brackets 602 of the device 600. In this way, forces transferred through the bracket 602 can be transferred through the non-metallic barrier 612, and forces transferred through the non-metallic barrier 612 can be transferred to the bracket 602. In this way, forces transferring through the conductor 608 and/or the heat generating component 604 are minimized during use.

In at least one example, the non-metallic barrier 612 defines a pathway through which the conductor 608 extends. In one or more examples, the non-metallic barrier 612 can be molded, additively manufactured, machined, or otherwise formed to define a pathway extending through the non-metallic barrier 612. In such examples, the conductor 608 can be disposed at least partially within the non-metallic barrier 612 and extending through the pathway defined thereby. In at least one example, the conductor 608 can include a metal. In at least one example, the conductor 608 can include a thermal paste. In at least one example of the device 600, the heat generating component 604 can include an LED. In at least one example, the LED 604 can be configured to emit light through the aperture 605.

As noted with reference to other examples described herein, the non-metallic barrier 612 of FIG. 6 is configured to shield the nearby RF sensitive components 614a-b and associated components 616a-c from interference caused by electricity conducted through the conductor 608 from the heat generating component 604 to the electrical ground 610. In at least one example, the electrical ground 610 can additionally or alternatively be configured as a heat sink where heat generated by the heat generating component 604 is transferred through the conductor 608 thereto. The non-metallic barrier can also be configured to structurally support the device, including the heat generating component 604, the electrical ground 601, or any other components of the device 600 including the bracket 602. In this way, the non-metallic barrier can structurally relieve the conductor 608 and/or the heat generating component 604.

Accordingly, in the example shown in FIG. 6, the dimensions, size, and configuration of the conductor 608 can be physically minimized to reduce RF interference and heat transfer to other components within the device 600 while the non-metallic barrier 612 carries the forces to maintain or improve durability. The non-metallic barrier 612 can also reduce design requirement for how tightly packed the various RF sensitive components 614a-b can be in relation to the conductor 608, enabling a more physically compact design. Because of this compact design and the reduction in a minimum allowable distance D1 and D2 between RF sensitive components 614a and 614b, respectively, and the conductor 608, more components and modules of various functionalities, whether they be RF sensitive modules or not, can be disposed within the internal volume 603 of the device 600, or on or within the bracket 602, such that the functionalities of the device 600 can be greater in number and improved in performance.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

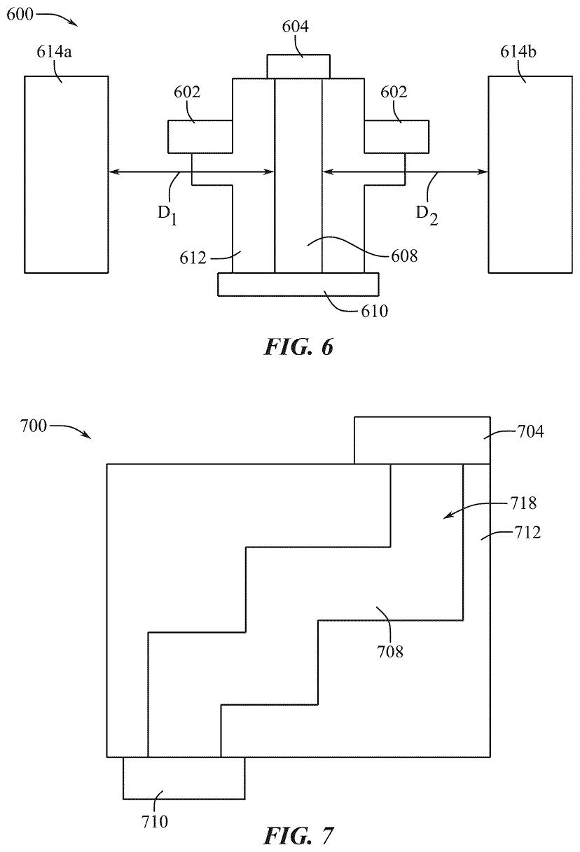

FIG. 7 illustrates an example of an electronic component 700 including a heat source 704, an electrical ground 710, and a non-conductive body 712 defining a pathway 718 extending from the heat source 704 to the electrical ground 710. In at least one example, the body 712 can be formed to define a non-linear or otherwise tortuous pathway in any configuration as needed to extend from the heat source 704 to the electrical ground 710. In at least one example, the body 712 can be an RF and/or heat barrier, similar to other barriers and RF barriers described with reference to other examples. In at least one example, the pathway 718 defined by the body 712 can include a central longitudinal axis extending in two or three dimensions. In this way, the pathway 708 can be formed to wind and extend between various RF sensitive and/or heat sensitive components within a device, which may be positioned at any location relative to the heat source and/or electrical ground, such that the body 712 is disposed between any heat or RF sensitive components and the pathway 718. In at least one example, the body 712 can be a non-metallic barrier configured to structurally support a device or components therein, including the heat source 704 and the electrical ground 710. In at least one example, the body 712 can include a plastic material. In at least one example, the body 712 can be rigid or plastic such that it is not meant to elastically deform as part of its normal function. In at least one example, the non-metallic barrier 512 can include a rigid material that is not meant to be elastically or plastically bent as part of its functioning to structurally supporting the conductor 508 or other components described herein.

In at least one example, a conducting material 708 can be disposed within the pathway 718 and extend from the heat source 704 and the electrical ground 710 to conduct electricity and heat away from the heat source 704 and into the electrical ground 710. The electrical ground 710 can also be a heat sink in one or more examples. The pathway 718 can be an enclosed pathway terminating at openings defined by the body 712. The enclosed pathway 718 can include an elongate pathway, for example a tubular pathway, with opposing ends at respective openings defined by the body 712. A first end of the pathway 718 can terminate at the heat source 704 and the second end of the pathway can terminate at the electrical ground 710. The term “enclosed” can refer to a pathway fully defined by the body 712 such that the only access to the pathway 718 includes opening at either end defined by the body 712, as noted above.

In at least one example, the body 712 can be additively manufactured or otherwise formed to define the irregular, non-linear, and/or tortuous pathway 718 and then a thermal paste, gel, or conducting liquid can be injected into the pathway 718. In one example, after the pathway 718 is formed, heated liquid metal can be injected or molded into the pathway 718 and can then cool/solidify therein. Once the pathway 718 has been defined by the formation of the body 712, material portions of the body 712 can be removed to accommodate or provide space for various other components within an electronic device, including RF sensitive components or other heat sensitive components requiring shielding from the conducting material 708. That is, while the illustrated body 712 shown in FIG. 7 is rectangular in shape, the outer surfaces and edges of the body 712 can be removed and/or customized to fit between any number of electrical components and the conducting material 708 disposed in the pathway 718.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

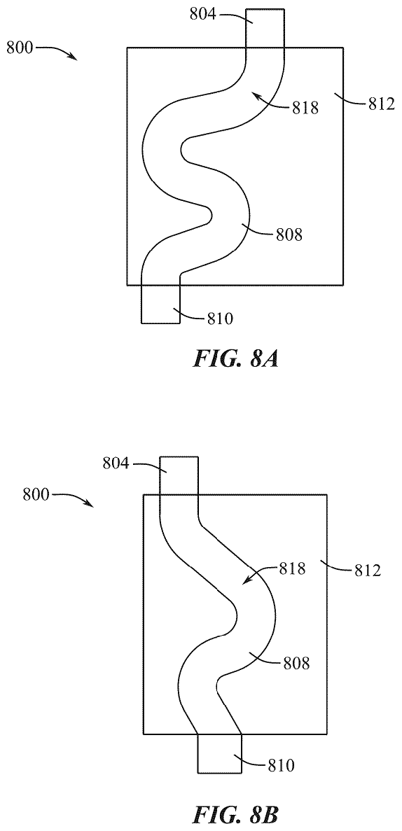

FIGS. 8A and 8B show front and side views, respectively, of another example of a device 800 including a heat source 804, an electrical ground 810, a non-conductive body 812 defining a pathway 818 extending from the heat source 804 to the electrical ground 810. In at least one example, the body 812 can be formed to define a tortuous pathway in any configuration as needed to extend from the heat source 804 to the electrical ground 810. The front and side view of FIGS. 8A and 8B, respectively, are shown to illustrate the three-dimensional nature of the pathway 818. In at least on example, the configuration, curvatures, and directions of the pathway 818 can be tuned to accommodate other electronic components within an electronic device, as discussed above, such that the body 812 maintains a disposition between the pathway 818 and the conducting material 808 disposed therein to act as a barrier between the conducting material 808 and any heat or RF sensitive components adjacent or nearby the body 812.

In this way, the body 812 can be an RF and/or heat barrier, similar to other barriers and RF barriers described with reference to other examples. In at least one example, the pathway 818 defined by the body 812 can include a central longitudinal axis extending in two or three dimensions. In this way, the pathway 808 can be formed to wind and extend between various RF sensitive and/or heat sensitive components within a device, which may be positioned at any location relative to the heat source and/or electrical ground, such that the body 812 is disposed between any heat or RF sensitive components and the pathway 818. In at least one example, the body 812 can be a non-metallic barrier configured to structurally support a device or components therein, including the heat source 804 and the electrical ground 810. In at least one example, the body 812 can include a plastic material.

Any of the features, components, and/or parts, including the arrangements and configurations thereof shown in FIG. 8A-B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

According to some examples, personal information data can be used the present exemplary system and method to enhance and improve the function and personal experience of a user. However, if personal information data is gathered and/or used, it should be gathered and used according to well established and authorized secure privacy policies and practices that are appropriate for the type of data collected. While personal information data may be used by the present exemplary systems and methods, such information is not necessary for performance of the contemplated systems and methods.

Furthermore, it will be understood that the present systems and methods can be varied and combined, or incorporated with alternative components. The scope of the present systems and methods will be further understood by the following claims.

What is claimed is:

1. An electronic device, comprising:
a heat generating component;
an electrical ground;
a radio-frequency (RF) sensitive component;
a conductor extending from the heat generating component to the electrical ground; and
a non-metallic, structural barrier surrounding the conductor and disposed between the conductor and the RF sensitive component.

2. The electronic device of claim 1, wherein the conductor comprises metal.

3. The electronic device of claim 1, wherein the heat generating component comprises a light-emitting diode (LED).

4. The electronic device of claim 1, wherein:
the non-metallic barrier defines a pathway; and
the conductor extends through the pathway.

5. The electronic device of claim 1, wherein the RF sensitive component comprises an antenna.

6. The electronic device of claim 5, wherein:
the antenna comprises a first antenna;
the electronic device further comprises a second antenna;
the non-metallic barrier is disposed between the conductor and the first antenna; and
the non-metallic barrier is disposed between the conductor and the second antenna.

7. The electronic device of claim 6, wherein the conductor comprises a thermal paste.

8. The electronic device of claim 1, further comprising a housing defining an internal volume and an aperture.

9. The electronic device of claim 8, wherein the heat generating component comprises an LED positioned to emit light through the aperture.

10. The electronic device of claim 8, wherein the RF sensitive component is disposed in the internal volume.

11. An electronic component, comprising:
a heat source;
an electrical ground;
a plastic body defining an enclosed pathway extending from the heat source to the electrical ground; and
a conductive material disposed in the pathway.

12. The electronic component of claim 11, wherein the conductive material comprises a thermal paste.

13. The electronic component of claim 11, wherein the conductive material comprises a metal.

14. The electronic component of claim 11, wherein the plastic body comprises a rigid material.

15. The electronic component of claim 11, wherein the pathway is tortuous.

16. The electronic component of claim 11, wherein the pathway extends in three dimensions.

17. A head-mountable device, comprising:
a display portion including a display screen and a housing defining an aperture,
an LED positioned in the aperture;
a second electronic component;
a plastic RF barrier extending from the LED to the second electronic component;
a pathway defined by the RF barrier; and
a conductor structurally supported by the plastic RF barrier and extending through the pathway and connecting the LED to the second electronic component.

18. The electronic device of claim 17, further comprising an antenna disposed adjacent to the RF barrier.

19. The electronic device of claim 18, wherein the RF barrier is disposed between the conductor and the antenna.

20. The electronic device of claim 17, wherein the conductor comprises a thermal paste.
